(19) United States
(12) Patent Application Publication
(10) Pub. No.: US 2014/0337463 A1
(43) Pub. Date: Nov. 13, 2014

(54) Location Based Processing of Data Items

(71) Applicant: Sweet Mustard, Inc., (US)

(72) Inventor: Georg Treu, San Francisco, CA (US)

(21) Appl. No.: 13/891,261

(22) Filed: May 10, 2013

(51) Int. Cl. H04L 29/08

(52) U.S. Cl. CPC H04L 67/18
USPC 709/217

(57) ABSTRACT

A method includes transmitting a first data item from a first data processing device within the network, determining the distance between a first position and a plurality of second positions associated with second data processing devices. At a first point in time, when the distance between the first position and each of the second positions is below a threshold, each of the second data processing devices is enabled to receive, access or display the first data item. After a first point in time, one or more second data items from the first data processing device are transmitted, and even if the distance between any of the second positions associated with the second data processing devices and the first position is above the threshold, each of the second data processing devices are enabled to receive, access or display the second data items.

### BACKGROUND OF THE INVENTION

One aim of location-based services (LBS) is to enable strangers of the same interest and geographical proximity to engage in meaningful and socially acceptable conversations via mobile devices, in particular smartphones. To achieve this, the following issues need to be addressed:

1. Addressing a Group of Users

That is, addressing more than one person with each message. Group addressing in combination with reliable identity is important in order for communication threads to be self-policing, that is, for the conversation to remain socially acceptable.

In the following, services that do not enable group addressing, but just messages between individuals, are referred to as “1-1 back channel”.

2. Open Membership

Group communication is widely used throughout the Internet. Some groups can be joined openly, while others require administrative permission by an authorized person or a quorum of authorized persons. Groups that can be joined openly are preferable if the LBS system is to be flexible and scalable.

3. Multiple Threads

For group communication to be scalable, it needs to be multithreaded, that is, allowing more than one communication thread at a time between members of a group. In a LBS environment this means that members who do have overlapping interests and geographical proximity can still have multiple threads with different subgroups at the same time. To illustrate this: The Facebook® news feed enables multithreaded communication in the form of individual posts. Each post and its comments represent a single thread. Therefore the Facebook news feed is scalable. Twitter (RTM) is also scalable. Each tweet can be seen as a thread. On the other hand, chat rooms (and also location-based chat rooms) are not multithreaded. Everybody talks to everybody all the time and there is no way to spark another thread in the same chat room, except for private messages. However, private messages do not meet the requirements 1. and 2. above.

4. Manageability

Members of a group communication should be able to keep track and actively participate in the communication. Non-location-based services such as the Facebook News Feed and Twitter meet this requirement. Conversation threads (Posts/Tweets) are organized in chronological order. With memberships and followings managed by the user and relatively static, users feel they understand what is going on due to the chronological nature of new items.

A challenge in the environment of LBS is to deal with the geographical position of the user, in addition to time. Because of this, conventional LBS systems have not been able to meet requirement 4. in addition to the other requirements above.

For example, one approach that meets requirements 1. to 3. is what is referred to herein as “post-it-notes”. In this approach, Users post communication threads (messages, pictures, videos, etc.) on a virtual map, either at their current geographical position, or a position they deem relevant for the posted content. When matched to known places, such posts may constitute a good recommendation service, that is, a service that helps people find interesting venues on a map.

However, these posts are not sufficiently manageable to allow for a meaningful group communication.

There are internet-based services that appear to meet requirements 1. to 4 to some extent. Examples are Facebook open groups, some of which are specific to a location. In the following, services of this type are referred to as “explicit local groups”.

One of the problems of explicit local groups is that they still require an active group management based on location.

An alternative to explicit local groups are “static local groups” where group membership is based on location. However, in this approach groups are organized according to a fixed geographical grid, which has the disadvantage that members at the geographical borders of these grids may have a skewed spatial relationship to the other members in the group (grid cell).

5. Implicit Group Membership Based on Geographical Proximity

According to this requirement users are able to participate in a group communication based on their geographical proximity only, instead of having to actively join or leave groups. This reduces the management overhead associated with group membership and allows users to change their location (or context) while still maintaining a meaningful group conversation without having to explicitly change groups. It also makes it easier to discover (or automatically detect) and join relevant groups compared to static or explicit local groups.

The present invention aims to provide an LBS system that meets some, preferably all of the above requirements.

### SUMMARY OF THE INVENTION

According to one aspect of the invention, there is provided a method of processing data items in a data communications network, the method comprising: transmitting a first data item from a first data processing device within the communications network; determining the distance between a first position and a plurality of second positions each associated with respective second data processing devices within the communications network; determining a subset of said second data processing devices, wherein, at a first point in time, the distance between the first position and each of the second positions associated with said second data processing devices of said subset is below a threshold; enabling each of said second data processing devices of said subset to receive or access or display said first data item; after said first point in time, transmitting one or more second data items from said first data processing device; and enabling each of said second data processing devices of said subset to receive or access or display said second data items even if the distance between any of the second positions associated with said second data processing devices of said subset and said first position is above said threshold.

The first position may be the position of the first processing device. Thus, a communication thread can be based on the location of a user of the first device (first user) or a location selected by the first user, e.g. his preferred location for a certain activity.

A subsequent communications thread can develop based on the proximity of another user to that location.

For example, the first user may generate and transmit a first message (first data item). A user of a second device (second user) who is within the proximity threshold can receive and display the message. If, subsequently, the second user moves outside the proximity threshold, and the first user generates a new message, the second user may receive and display that message even though he is currently outside the proximity threshold. In contrast, a third user who is currently outside the proximity threshold and who also was outside the proximity threshold when the first message was transmitted is not enabled to receive and/or display the second message.

Thus, messages are managed based on the location of users relative to one another at the time of the transmission of the first message by one of the users.

Alternatively, the second user may select a location using his data processing device. Such location does not necessarily correspond to his physical location. In this alternative, a subsequent communications thread can develop based on the distances between the selected locations of the first and second users.

The first message and any subsequent messages in response thereto define a communications thread. Any user can engage in a plurality of different threads. Together, the threads constitute the user's newsfeed. In the newsfeed, the various threads are listed chronologically.

In an embodiment, the invention further comprises enabling said first data processing device to display a third data item transmitted in response to said first or second data item by any of said second data processing systems of said subset even if the distance between the first data processing device and the second data processing device that transmits said third data item is above said threshold.

According to this embodiment, the second data processing devices are enabled to comment on the first message from the first device, i.e. to append messages (comments) to the thread that the first device has created with its initial message (the first data item).

In an embodiment, the first and second data items constitute a communications thread, wherein the method further comprises establishing a plurality of communications threads on the first data processing device, and displaying and/or making accessible the plurality of communications threads in chronological order on the first data processing device. Thus, users are enabled to manage several location-based threads chronologically.

In an embodiment, each data item is associated with a data tag, wherein all data items of a communications thread are associated with the same data tag, and data items of different communications are associated with respective different data tags. The data tags may represent locations, activities or other parameters.

In an embodiment, the invention further comprises generating associations between different data items; and enabling each of said second data processing devices of said subset to display said second data items only if said second data items are associated with said first data item. In particular. each data item may be associated with a data tag, and any two data items are associated with one another if they are both associated with the same data tag.

In this embodiment, threads are generated and managed based (1) on the location of users relative to one another at the time of the transmission of the first message by one of the users, and (2) associations between messages. Messages can be considered associated with one another if they belong to the same category. There may be numerous different categories. Each category may represent an activity of interest. On a technical level, this is achieved by providing data tags indicative of different categories.

Accordingly, for a new message to be added to an existing thread, in addition to the above described embodiments, it must belong to the same category.

In one embodiment, on a given data processing system, a new thread of data items is generated each time a data item is generated or received that is associated with a new data tag. The data tag may be indicative of a location. Different data tags may be indicative of different respective locations. Thus, each user can manage different threads, each containing messages relating to different respective locations and/or activities, for example.

The location indicated by a data tag may be different from the location of the user who generates the corresponding message. Thus, users can initiate chats in respect of any locations of interest.

In an embodiment of the invention the method includes generating news items regarding a multitude of physical locations, each associated with a certain interest and/or activity (e.g. surfing, hiking, playing chess etc.).

In an embodiment, each user is associated with one or more data tags. Each data tag defines an interest (e.g. surfing) and an associated location. The location can be the physical location of the user (in the past or present, or planned), or it can be a manually set location (e.g. user's favorite surfing break).

Based on his data tags and the described mechanism, a user can become a member of different threads over time. The different threads are listed and accessible in the user's newsfeed in chronological order.

In an embodiment the method comprises enabling a user to have plurality of different interests associated with a location, listening to incoming posts for the plurality of interests, each corresponding to a thread, and combining these in one feed.

In an embodiment of the present invention, each thread has its fixed point in time of creation. The thread can only be accessed by users who are in proximity, or who have selected a position proximate to the post creation location at time t. This is in contrast to post-it-notes (as described above) which can be accessed even by users who were not located at the respective position at time t. In other words, in contrast to post-it-notes, the above requirement 4. is met.

In addition, in contrast to location-based chat rooms, multiple conversations and/or threads and/or posts can be created between a subset of the same group of people. In location-based chat rooms, users can talk to everybody who is currently nearby which leads to a single threaded mode and a violation of the above requirement 3.

In an embodiment of the invention, a first data processing device enables a third data processing device to display said first data item even though the distance between the third data processing device and the first data processing device is above said threshold. In other words, the first user can add friends to his thread regardless of their position relative to him.

In an embodiment of the invention, the enabling of some or all of said second data processing devices of said subset to receive or access or display said second data items is deferred by a predetermined period of time. Thus, the initial message (the first data item) is not immediately (at the time t) included in the news feeds of the second users who qualify for the message (i.e. qualify by being in proximity to the sender at time t). Instead, the message is delayed. One specific application of this feature is to test the appeal to a subset of users of a message or proposed data thread first. If some or many users respond positively (by indicating so, commenting, clicking on the photo etc.), the message may be made available to all users that qualify for it, even after a certain amount of time has already passed. Nevertheless, the message can still be sorted chronologically into the users' respective newsfeeds, despite the delay. In particular, the chronological order can be maintained as if the delay has not occurred. In another application, this feature can be used to detect spam.

In an embodiment, the invention comprises restricting said subset based on one or more predetermined attributes. That is, messages are not necessarily shown to all users that qualify based on interest/proximity. Instead, it is possible to filter users based on criteria such as whether or not users have a premium account, they are part of a certain demographic group, or any other definable attributes.

In an embodiment, the method comprises adapting the threshold after the first data item has been transmitted, and applying the threshold retroactively in determining the subset. This feature can be used, for example, by advertisers to increase the geographic reach even after the first message was sent. This feature can also be used to retroactively undo some or all of the filtering of users described above.

In an embodiment, the first data processing device is operable to set the threshold. Alternatively, the second data processing devices are operable to set respective thresholds for the second processing devices. In another embodiment, the threshold is determined dynamically. For example, the threshold can be calculated dynamically in a way that a certain minimum or maximum or exact number of users receives the first message (e.g. the k nearest-neighbors). For example, in this embodiment, the first message can be sent to the ten users with the closest data tags for a certain activity, say basketball.

In an embodiment, the method comprises enabling selected data items to be added to a communications thread, wherein the selected data items are associated with data tags indicative of a point in time within a predetermined time period before said first point in time. In other words, when a user sets up a new data tag (e.g. to express interest in a certain activity at a certain location), the system may backdate this newly created data tag in time. This way, the user can already have threads in his news feed as soon as he sets up the tag by including him/her into threads that were started at the desired location, but earlier in time. The purpose of this embodiment is to solve the emptiness problem, which occurs when users set up new data tags or when they are new to the system.

The first data processing device and/or the second data processing devices are mobile devices, in particular mobile telephones (“smartphones”).

### BRIEF DESCRIPTION OF THE DRAWINGS

FIG. 1 is an operational diagram of the interaction between users of the system with respect to distance, and wherein each user is associated with one data tag.

FIG. 2 is an operational diagram of the interaction between users of system wherein the location of the respective users remains constant, and wherein the users have a plurality of data tags.

### DETAILED DESCRIPTION

A method according to an embodiment of the invention comprises the following steps:

A user X posts a message (text, picture, video, audio, etc.) at time t to the system. The system determines the location of the user and the locations of all other users in the system. Based on all users' locations, their expressed interests, and/or potential additional filtering mechanisms, the system determines a subset of all users, U, which meets the requirement Distance (U, X, t)<d, with d being a predefined or computed-on-the-fly proximity threshold. That is, at time t the distance between U and X is less than or equal to d. A new message thread (in other words a post) is created, which comprises as message participants (that is, people who can comment on and see the post) all users U and X. Users U and X see the message thread (post) in their feed of messages. The message thread is time-stamped with time t. Users U and X can comment/like etc. on the message thread indefinitely into the future, until deleted or hidden.

According to this embodiment, the invention allows for a location-based feed consisting of chronologically sorted threads (local inbox) for all users in the system. The sorting can be done according to timestamp t and is easy to understand and manage.

Accordingly, in an embodiment, the invention enables a communication thread to be constituted by (a) a set of users U engaging in the communication and b) a set of messages exchanged over time between those users, with each message being addressed to all users in the thread. In particular, a communication thread is created by a user X sending a first message at time t. Based on X's position at time t (and, optionally, other parameters, such as the content of the message) and the position of all other users at time t, the set U is characterized in that each user in U has a distance to X less or equal to a predetermined threshold at time t.

In an embodiment, the thread remains stable (it “freezes”) over time in terms of group membership. This means that A) further messages (comments) on the thread can be exchanged subsequently between all users of the set U, even if their positions change and get outside of the threshold, and B) conversely even if, after t, other users not included in the set U get close to X (i.e. have a distance from X less than the predetermined threshold), or close to the position where the thread was created (that is, where the first message was sent), they will not become part of the thread.

Furthermore, each user can access and respond to a multitude of ongoing communication threads, which are listed in the user's feed chronologically.

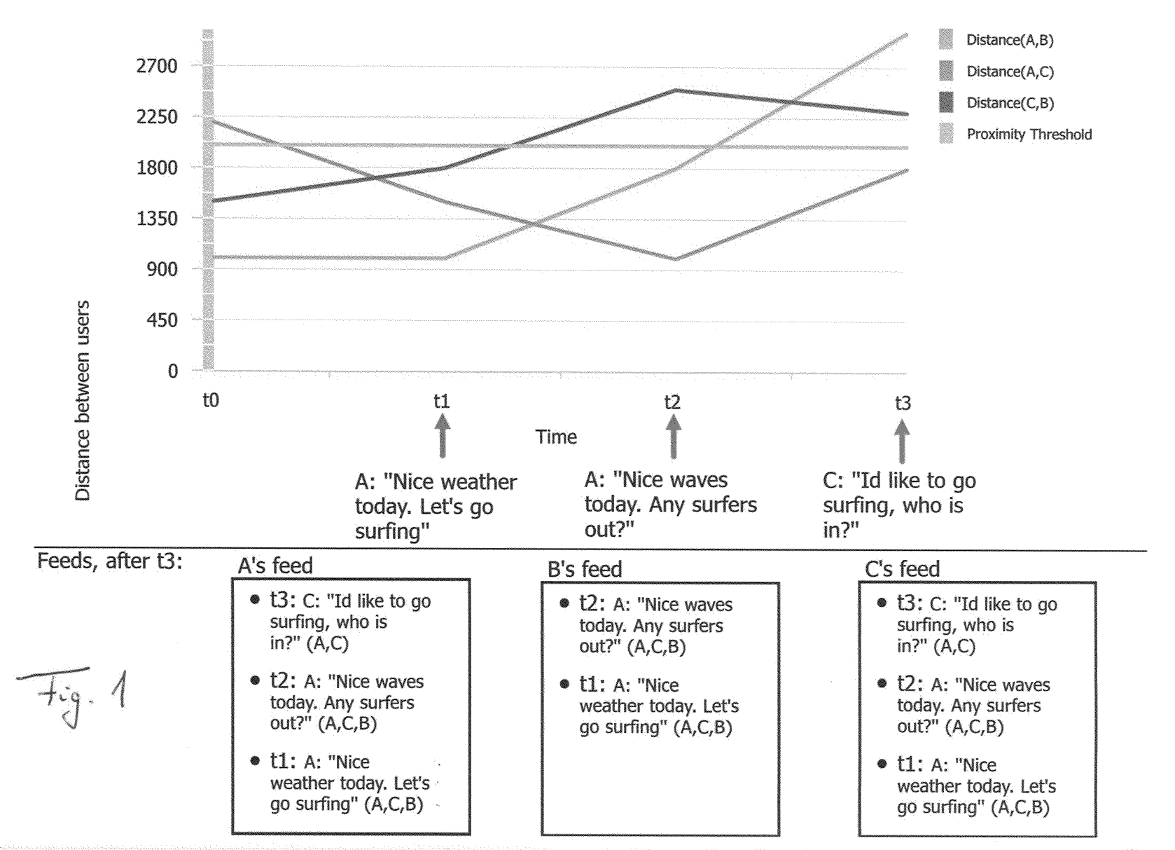

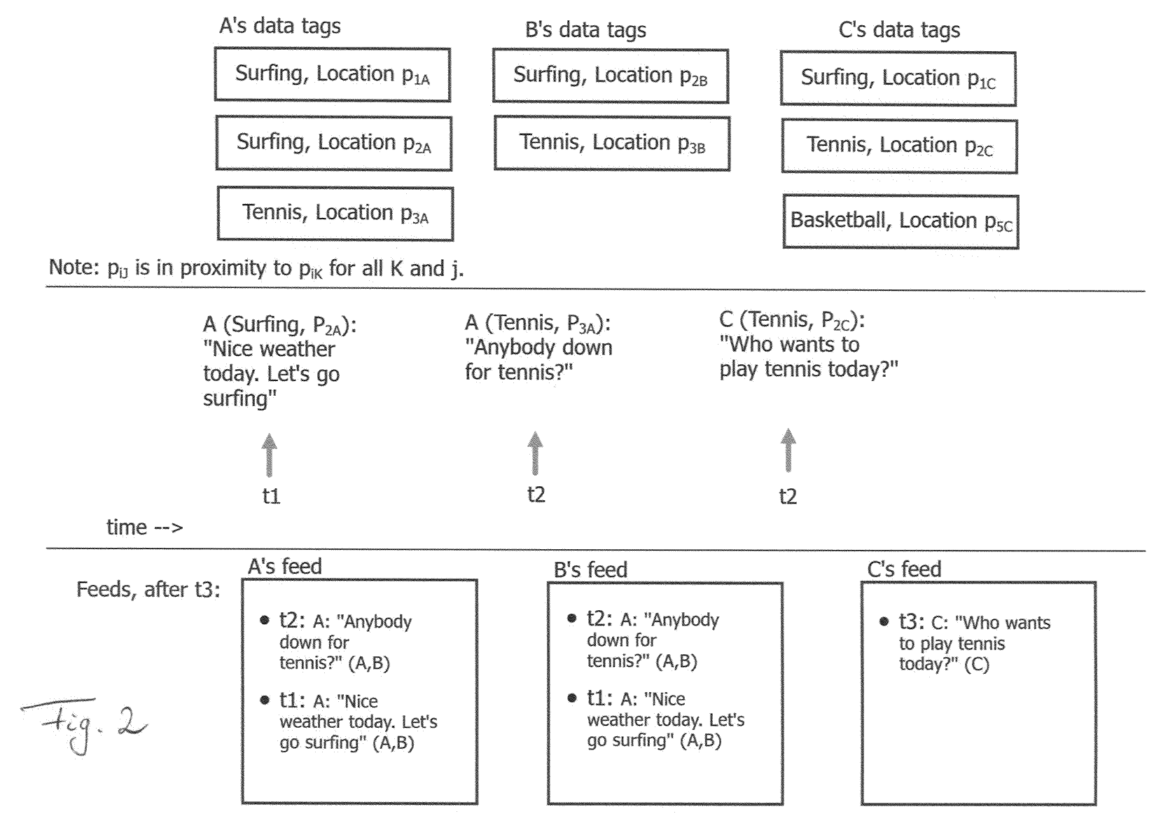

The operation of an embodiment of the present invention is illustrated in FIGS. 1 and 2. FIG. 1 shows the operation of an embodiment of the invention with respect to positions being updated over time. FIG. 2 shows the operation of an embodiment of the invention with regards to users having a plurality of data tags. In other words, while FIG. 1 illustrates one data tag per user and varies the associated location, FIG. 2 illustrates an example where the locations remain unchanged with a plurality of data tags per user.

In the embodiment shown in FIG. 1, there are three users in the system A, B and C. All three have expressed similar interest in engaging in group conversations about surfing with other users who are local. The proximity radius is set to d=2,000. Over the course of time the positions of A, B and C keep changing. The mutual distance (A, B), (A, C), and (B, C) are plotted in the chart. At predetermined discrete time intervals t1, t2, t3, message threads are created. Each message thread is represented by a post on each of the users' feed. As illustrated, access to the message threads (which enables to post comments, for example) is determined by the mutual distances of the users in the system at a given time t. For example, in both cases when A creates a message thread, both, B and C, are sufficiently close. Therefore both B and C get added to the conversation, and both B and C have a respective post in their feed. On the other hand, when C sends a message at time t3, B is not sufficiently close to C. Therefore, only A gets added to this thread.

Accordingly, the present invention according to the illustrated embodiment provides a simple-to-manage chronological feed for each individual user (requirement 4.) while at the same time allowing for implicit group membership based on location (requirement 5.).

FIG. 2 illustrates an embodiment of the invention. Users A,B,C participate in the data communication system, with each of the users being associated with a set of data tags. Each data tag denotes the user's interest in a certain activity (e.g. tennis) associated with a certain location (e.g. a tennis court). The location may be the user's current physical location, or it may be a different, pre-configured location.

FIG. 2 shows how three posts get created over time; two created by user A, one about surfing and one about tennis, and one post created by user C about tennis. FIG. 2 shows further how the news feeds of the three users get populated with those posts over time dependent on the data tags each user has set up: Both posts by A appear in the feed of B, because A and B share data tags about tennis and surfing associated with locations in proximity. However, the post C creates at time t3 is shown neither on A's nor B's news feed, because their data tags for tennis are not in proximity to C's.

1. A method of processing data items in a data communications network, the method comprising:
transmitting a first data item from a first data processing device within the communications network;
determining the distance between a first position and a plurality of second positions each associated with respective second data processing devices within the communications network;
determining a subset of said second data processing devices, wherein, at a first point in time, the distance between the first position and each of the second positions associated with said second data processing devices of said subset is below a threshold;
enabling each of said second data processing devices of said subset to receive or access or display said first data item;
after said first point in time, transmitting one or more second data items from said first data processing device; and
enabling each of said second data processing devices of said subset to receive or access or display said second data items even if the distance between any of the second positions associated with said second data processing devices of said subset and said first position is above said threshold.

2. The method of claim 1, further comprising:
enabling said first data processing device to receive or access or display a third data item transmitted in response to said first or second data item by any of said second data processing systems of said subset even if the distance between the first position and the second position associated with the second data processing device that transmits said third data item is above said threshold.

3. The method of claim 1, wherein the first and second data items constitute a communications thread, the method further comprising:
establishing a plurality of communications threads on the first data processing device; and
at least one of displaying and making accessible the plurality of communications threads in chronological order on the first data processing device.

4. The method of claim 1, wherein the first and second data items constitute a communications thread, wherein each data item is associated with a data tag, and wherein all data items of a communications thread are associated with the same data tag, and data items of different communications threads are associated with respective different data tags.

5. The method of claim 1, further comprising:
generating associations between different data items; and
enabling each of said second data processing devices of said subset to display said second data items only if said second data items are associated with said first data item.

6. The method of claim 5, wherein each data item is associated with a data tag, and wherein any two data items are associated with one another if they are both associated with the same data tag.

7. The method of claim 4, wherein said first data items and second data items generated in response to at least one of said first and second data items are associated with the same data tag.

8. The method of claim 4, wherein, on a given data processing system, a new thread of data items is generated each time a data item is generated or received that is associated with a new data tag.

9. The method of claim 4, wherein each data tag is indicative of at least one of a location, time and user-definable attribute or descriptor.

10. The method of claim 4, wherein the data tag is indicative of the time at which the first data item has been generated or transmitted by the first data processing device or received by the second data processing device.

11. The method of claim 4, wherein the data tag is associated with a location different from the location of the data processing device that generates the corresponding data item.

12. The method of claim 4, wherein at least one of said first and second positions are represented by respective ones of said data tags.

13. The method of claim 4, enabling selected data items to be added to a communications thread, wherein the selected data items are associated with data tags indicative of a point in time within a predetermined time period before said first point in time.

14. The method of claim 1, wherein the first data processing device enables a third data processing device to receive or access or display said first data item even though the distance between the third data processing device and the first position is above said threshold.

15. The method of claim 1, wherein the enabling of some or all of said second data processing devices of said subset to receive or access or display said first data item is deferred by a predetermined period of time.

16. The method of claim 1, further comprising restricting said subset based on one or more predetermined attributes.

17. The method of claim 1, further comprising adapting said threshold after said first data item has been transmitted, and applying said threshold retroactively in determining said subset.

18. The method of claim 1, wherein the first data processing device is operable to set the threshold.

19. The method of claim 18, wherein the first data processing device is operable to input a data tag indicative of the threshold.

20. The method of claim 1, wherein the second data processing devices are operable to set the threshold individually for each of the second data processing devices.

21. The method of claim 16, wherein the second data processing devices are operable to input data tags indicative of the individual thresholds for each of the second data processing devices.

22. The method of claim 1, wherein the threshold is determined dynamically.

23. The method of claim 1, wherein at least one of the first position corresponds to the position of the first processing device, and the second positions correspond to the respective positions of the associated second data processing devices.

24. The method of claim 1, wherein the first data processing device is operable to set the first position.

25. A device for managing the processing of data items in a data communications network, the device comprising processing means adapted to:
in response to a transmission of a first data item from a first data processing device within the communications network, determine the distance between a first position and a plurality of second positions each associated with respective second data processing devices within the communications network, and determine a subset of said second data processing devices, wherein, at a first point in time, the distance between the first position and each of the second positions associated with said second data processing devices of said subset is below a threshold;
enable each of said second data processing devices of said subset to receive or access or display said first data item; and
in response to the transmission of one or more second data items from said first data processing device after said first point in time, enable each of said second data processing devices of said subset to receive or access or display said second data items even if the distance between any of the second positions associated with said second data processing devices of said subset and said first position is above said threshold.

26. A computer readable medium comprising a program executable by a data processing system to:
in response to a transmission of a first data item from a first data processing device within the communications network, determine the distance between a first position and a plurality of second positions each associated with respective second data processing devices within the communications network, and determine a subset of said second data processing devices, wherein, at a first point in time, the distance between the first position and each of the second positions associated with said second data processing devices of said subset is below a threshold;
enable each of said second data processing devices of said subset to receive or access or display said first data item; and
in response to the transmission of one or more second data items from said first data processing device after said first point in time, enable each of said second data processing devices of said subset to receive or access or display said second data items even if the distance between any of the second positions associated with said second data processing devices of said subset and said first position is above said threshold.
